(19) United States
(12) Patent Application Publication
(10) Pub. No.: US 2007/0199988 A1
(43) Pub. Date: Aug. 30, 2007

(54) Method and means for detection of counterfeit items and prevention of counterfeiting activities

(76) Inventors: Marc R. Labgold, Reston, VA (US); Lacy Kolo, Leesburg, VA (US)

Correspondence Address: Lacy Kolo, 14591 Golden Oak Road, Centreville, VA, 20121, US

(21) Appl. No.: 11/526,211

(22) Filed: Sep. 25, 2006

Related U.S. Application Data
(60) Provisional application No. 60/719,610, filed on Sep. 23, 2005.

(51) Int. Cl. G06Q 30/00

(52) U.S. Cl. 235/385

(57) ABSTRACT

This invention relates to the use of radio frequency identification (RFID) tags and labels, as a means of preventing and/or detecting counterfeiting in the fashion, jewelry, timepiece, art, luxury goods and wearable accessory industries and the authentication of bona fide articles and/or their owners.

### RELATED APPLICATIONS

This application claims priority to U.S. Ser. No. 60/719,610 filed Sep. 23, 2005.

### BACKGROUND OF THE INVENTION

There exists an ever-increasing problem of counterfeiting within the fashion industry. Manufacturers, such as fashion design houses, go to great lengths to minimize, reduce and/or eliminate the manufacture and sale of counterfeit fashion-related products, such as handbags, luggage, shoes, ready to wear clothing, haute couture clothing, jewelry, timepieces and other accessories.

Representative examples of design houses whose trademarks and products are counterfeited include such well-known brands as Louis Vuitton, Dior, Prada, Gucci, Chanel, Armani, Versace, Yves St. Laurent, Valentino, Kate Spade, Burberry, Ralph Lauren, Rolex, Frank Muller, Piaget, Patek Phillip, and the like. Evidence of the prevalence of counterfeiting and its adverse impact on the individual manufactures and the industry as a whole is prevelant. A simple search on the internet or, for example, sites such as Ebay, reveal an abundance of counterfeit products being offered for sale. The efforts to stop such counterfeiting activities are immense; for instance, Louis Vuitton notes on its web site that 13,000 complaints were filed in the preceding year alone.

Counterfeiting deprives the rightful owner of designs, trademarks and trade dress of income from the loss of sales. In addition, such counterfeiting dilutes the value of the original products/marks. Further, the introduction of counterfeit goods of lesser quality that are not manufactured by the original designer can diminish the value of the original goods, the trademarks/trade dress involved and the overall goodwill earned and rightfully enjoyed by the original designer/owner.

Many counterfeits are obvious contraband goods, e.g., the patterns, colors, marks, elements or the like are not exact copies of the original. However, many counterfeits are close copies that can require a qualified examination to identify. With the increase in low cost manufacture of goods in foreign jurisdictions such as China, it has become more difficult for manufactures and law enforcement agencies to police counterfeiting activities. There exists a need to be able to rapidly determine whether a product is authentic as opposed to counterfeit.

Various techniques and methods have been used to prevent the counterfeiting of products and provide a means of authentication. Copy protection and authentication methods have included printing or stamping microscopic features that are difficult to reproduce, such as optical holograms as shown, for example, in U.S. Pat. No. 5,729,365. Other methods have employed the use of detectable chemical or biological compounds. Yet other methods have employed materials and inks that exhibit a detectable visual response when subject to a unique physical stimulus, such as fluorescent dye or thermochromic ink as shown, for example, in U.S. Pat. No. 6,264,107. A limiting and undesirable feature of known methods includes that they either require line-of-sight or require the use of complex detection equipment.

Rather than marking the object or article directly, it is common practice to affix to the object a label containing the aforementioned physical properties for anti-counterfeiting and authentication. Examples of the use of labels for these purposes can be found in a wide range of items and products, including important documents, photographic film, audio/video tapes, designer jeans, and expensive bottles of wine, designer athletic shoes, jewelry and other luxury items. In general, the function of these labels relies on visual/optical means of detection, for example, U.S. Pat. No. 4,558,318. It has also been contemplated to label an item with a label containing a radio frequency identification (RFID) tag, however this use has been limited embodiments that “match” the visible information on the label with the hidden information stored in the RFID tag, also affixed on the label, see for example, U.S. Pat. No. 6,226,619. This method, however, is faulty because there is no external database or way to verify that the label itself is not counterfeit.

The present invention provides anticounterfeiting methods and means which emplor RFID technology. RFID tags are an ideal way to label items because they can be manufactured in a small enough size to be non-intrusive to the look or feel of an item. RFID systems consist of a number of components including tags, handheld or stationary readers, data input units and system software. RFID tags and labels come in a variety of forms such as, inter alia, in roll form, so-called “chips” (in reference to their computer chip nature), laminated between paper or plastic, pellets, fobs, labels and the like, etc. The cost associated with the manufacture and use of RFID devices has greatly decreased and its acceptance in the retail environment continues to increase. Similarly, the types of RFID devices that are available continue to expand with respect to format, shape, size, and functionality. An overview of the technology and its application is found in “RFID, Radio Frequency Identification,” Steven Shepard (2005 McGraw-Hill Publishing), the text of which is incorporated by reference.

The use of RFID devices (often referred to as tags, labels, chips, fobs, and the like) is increasing because of factors such as the ability to collect information about a product, place, time or transaction quickly, easily and without human error. It provides a contactless data link, without the need for line of sight or concerns about harsh or dirty environments that restrict other automatic ID technologies such as bar codes.

In addition, RFID can be employed as more than just an ID code; it can be used as a data carrier, with information being written to and updated on the tag on the fly.

In a preferred embodiment of the present invention, the purchaser/owner identifying information is encoded on the RFID either at the time of purchase or thereafter. This feature provides numerous benefits, including, inter alia, use in theft deterrent, loss recovery, warranty, service, repair, related product marketing and similar activities.

Today, RFID is used for such applications as vehicle and personnel access control, automotive anti-theft systems, product and asset tracking and supply chain automation. Additional applications include payment and loyalty, personal and vehicle and personnel access control, automotive security, product and asset tracking, sports timing, livestock identification, document management and supply chain automation. For example, RFID tags are used for so-called speed passes (passive or active transmission devices linked to a credit card or other account, examples of which include the MobileOil SpeedPass™, EZPass, or similar devices) and consumer anti-theft systems. Further, pets are often embedded with small RFID chips (which typically include unique registration code and/or breeder, veterinarian and/or owner information) so that they may be identified and returned if lost.

To date, the use of RFID in the context of identifying, authenticating, and anti-counterfeiting is limited. In particular, such use is not been employed in that fashion, jewelry, and luxury product industries. The present invention provides a cost effective and efficient method for addressing the counterfeiting problems in the luxury product industries.

### SUMMARY OF THE INVENTION

Embodiments of the present invention provide anti-counterfeiting methods and means which employ radio frequency identification (RFID). Embodiments of the present invention provides novel methods and means for determining the authenticity of any luxury item including but limited to fashion-related products. The methods and means of the present invention involve the use of RFID to authenticate fashion-related items including, inter alia, handbags, shoes, clothing, jewelry, accessories, and the like. In the context of the present invention the terms RFID, RFID device, RFID tag, RFID label, RFID chip, fob or other similar designations, are used interchangeably and the use of one term versus another is not intended to limit the scope of the invention or the particular embodiment unless otherwise indicated. One of ordinary skill in the art will readily understand and be able to determine the particular shape, form, structure, features of the particular RFID device that best suit a particular application.

Another object of certain embodiments of the invention is the use of RFID as a means of preventing, detecting and anti-counterfeiting in the fashion, jewelry, luxury and wearable accessory industries.

Another object of certain embodiments of the invention is to provide customer identification for fashion, jewelry, luxury and wearable accessory goods.

Another object of a preferred embodiment is to employ the RFID methods and means of the present invention as a means of anti-counterfeiting and/or authentication for handbags, luggage and similar products.

Another object of a preferred embodiment is to employ the RFID methods and means of the present invention as a means of anti-counterfeiting and/or authentication for luxury products.

Another object of a preferred embodiment is to employ the RFID methods and means of the present invention as a means of anti-counterfeiting and/or authentication for jewelry products.

Another object of a preferred embodiment is to employ the RFID methods and means of the present invention as a means of anti-counterfeiting and/or authentication for fashion products.

Another object of a preferred embodiment is to employ the RFID methods and means of the present invention as a means of promoting the sale and/or value of fashion, jewelry, luxury, wearable accessories handbags, luggage and similar products.

Another object of a preferred embodiment is to employ the RFID methods and means of the present invention as a means of facilitating the return (as a result of, inter alia, purchase, theft or loss), exchange, repair.

Another object of a preferred embodiment is to employ the RFID methods and means of the present invention as a means of customer identification and/or verification. In a further preferred embodiment, the customer in the identification can be used to identify the customer when they enter a company facility (such as a retail store) thereby allowing the customer to be greeted. Such use can enhance the value of the individual product and the product line in general by allowing the customer to have a sense of preferred treatment associated with a luxury lifestyle. It also presents opportunities for follow-on marketing of other luxury goods or products related to the goods carried by the customer into the company facility.

To permit wider usage and avoid the potential to raise privacy concerns, some embodiments permit the customer to either turn off or to temporarily disable the RFID at the time of purchase. The RFID can be disabled completely or only in regards to certain functions.

Other objects of the present invention will be readily apparent to those of ordinary skill in the relevant art from the disclosure contained herein.

To achieve these goals, RFID device(s) are employed having at least one item of encoded information selected from the group consisting of, inter alia, the manufacturers' name, manufacturers' unique identification coding, date of manufacture, location of manufacture, product code, SKU, location of sale, security code, particular number of an item in a limited series and similar types of information. Additionally, in accordance with the present invention the RFID can be modified at the point-of-transfer/sale, or subsequent to transfer/sale (or in the case of advance orders, in advance of the transfer/sale) to include at least one item of encoded information unique to the receiving party including such information selected from the group consisting, inter alia, customer name, customer identifier, customer account number, customer address, customer contact information and similar information.

### FIGURE DESCRIPTION

FIG. 1 illustrates a method of detecting a counterfeit luxury good in accordance with one embodiment of the invention.

FIG. 2 illustrates a method of detecting a counterfeit luxury good in accordance with one embodiment of the invention.

FIG. 3 illustrates a system in accordance with another preferred embodiment of the invention.

### DETAILED DESCRIPTION OF THE INVENTION

The present invention provides an economical and convenient method for identifying and/or authenticating fashion and other luxury products, such as handbags, luggage, shoes, ready to wear clothing, haute couture clothing, jewelry and other accessories and enables distinguishing such products from counterfeit products and the ability to determine whether a particular item is in fact authentic or a counterfeit. The term “luxury products” is intended to mean any item of significant value, the identification of which benefits from the methods of the present invention.

In general terms, the present invention involves the incorporation of an RFID device into the product to be sold. The placement of the RFID device is dependent upon the particular structure of and/or manufacturing method employed in manufacturing a given product. The particular form of device to be employed in conjunction with the application of the present invention will depend on the nature of the particular item to be tagged, the methods of manufacture employed, etc.

The present invention is not constrained to any particular RFID device(s). RFID tags exist and are contemplated in various shapes, sizes and read ranges including thin and flexible “smart labels” which can be laminated between paper or plastic. RFID creates a means for maintaining and accessing information about a product, place, time or transaction quickly, easily and without human error and with limited or no skill or expert knowledge base. It provides a contact-free data link, without need for line of sight or concerns about harsh or dirty environments that restrict other automatic ID technologies such as bar codes. In addition, RFID can be used to provide more than just an identifier code; it can be used, for example, as a data carrier, with information being readily written to and updated as desired. Examples of RFID tags can be found in U.S. Pat. Nos. 6,851,617, 5,682,143, 4,654,658, 4,730,188 and 4,724,427. See also, “RFID, Radio Frequency Identification,” Steven Shepard (2005 McGraw-Hill Publishing), the text of which is incorporated by reference.

The RFID devices of the present invention can be either active or passive. Passive RFID devices do not have their own power supply. The minute electrical current induced in the antenna by the incoming radio frequency scan provides enough power for the device to send a detectable response. Due to power and cost concerns, the response of a passive RFID device is brief—typically just an ID number (GUID). Lack of an on-board power supply allows the device to be quite small. Current commercially available passive RFID tags are as small as 0.4 mm×0.4 mm and are thinner than a sheet of paper, rendering them practically invisible.

Active RFID devices, on the other hand, typically have their own power source, and may have longer ranges and larger memories than passive tags, as well as the ability to store additional information sent by the transceiver. At present, the smallest active tags are about the size of a coin. Many active tags have practical ranges of tens of meters, and a battery life which can be in excess of several years.

The RFID devices of the present invention are not limited to operation in any particular frequency range. They can also operate using electromagnetic frequencies other than “radio” frequencies. In addition, they can use sound or different types of radiation to communicate between the device and the transceiver or other detection means. The present invention is not limited to any particular format of RFID.

In a typical RFID system, individual objects are equipped with a small, inexpensive tag. In its most common forms the RFID tag functions in response to a coded RF signal received from a stationary or mobile (which can be mounted or handheld) transceiver (commonly referred to as an interrogator). The tag reflects the incident RF carrier back to the interrogator. Information is transferred as the reflected signal is modulated by the tag according to its programmed information protocol. RFID tags typically contain a transponder with a digital memory chip that has, inter alia, a unique electronic code. The interrogator, an antenna packaged with a transceiver and decoder, emits a signal activating the RFID tag so it can read and/or write data to the tag. When an RFID tag passes through the detection zone, it detects the reader's activation signal. The reader decodes the data encoded in the tag's integrated circuit and the data is processed (either locally or remotely). The internal circuitry of the tag (including the transponder) may gain its operating power directly from a RF interrogation signal. U.S. Pat. No. 5,053,774, issued to Schuermann, describes a typical transponder RF interrogation system. The Schuermann patent describes in general the powering technology surrounding conventional transponder structures. U.S. Pat. No. 4,739,328, issued to Koelle, et al., discusses a method by which a conventional transponder may respond to a RF interrogation signal. Other typical modulation techniques, which may be used, include, for example, ISO/IEC 14443 and the like.

In one preferred embodiment, a RFID device is embedded in a handbag at the time of manufacture. The particular placement of the RFID device is not critical to the proper functioning of the present invention. In one embodiment, the RFID device is contained within the piping of the handbag material. In another embodiment, the RFID device is placed behind an integral label, such as the label identifying the manufacture or a particular product model. In another embodiment, the RFID device is embedded within the handle or strap. In another embodiment, the RFID device is embedded between two layers of material within the article. In a less preferred embodiment, the RFID device is embedded post manufacture.

Handbags are typically bags used to hold various small items, such as keys, tissues, makeup, and/or other personal items. Handbags are usually carried by women, but the term is not intended to be limited. Examples of handbags includes, but is not limited to, hobo bags, flap bags, tote, duffle, satchel, mini, carry-out, pouch, clutch, messenger, backpack, barrel, wallets, shopping bags, shoulder bags, camera bag, fanny pack, gym bags, briefcases, laptop bags, and the like.

In another preferred embodiment, a RFID device is embedded in an article of luggage at the time of manufacture. The particular placement of the RFID device is not critical to the proper functioning of the present invention. In one embodiment, the RFID device is contained within the piping of the luggage material. In another embodiment, the RFID device is placed behind an integral label, such as the label identifying the manufacture or a particular product model. In another embodiment, the RFID device is embedded within the handle or strap. In another embodiment, the RFID device is embedded between two layers of material within the article. In a less preferred embodiment, the RFID device is embedded post manufacture. Examples of luggage include, but is not limited to, carry-on luggage, garment bags, pet carriers, toiletry bags, jewelry cases, suitcases, golf bags, cooler bags, trunks, and the like.

In another preferred embodiment, a RFID device is embedded in a shoe at the time of manufacture. In this embodiment, one RFID can be placed into each shoe of the pair or a single RFID can be placed into a single shoe. The particular placement of the RFID device is not critical to the proper functioning of the present invention. In one embodiment, the RFID device is contained between the heel and the sole of the shoe. In another embodiment, the RFID device is placed behind an integral label, such as the label identifying the manufacture or a particular product model. In another embodiment, the RFID device is embedded beneath the inner sole. In another embodiment, the RFID device is embedded between two layers of material within the article. In a less preferred embodiment, the RFID device is embedded post manufacture. Examples of shoes include, but is not limited to, wingtips, loafers, flats, heels, slippers, sandals, boots, clogs, pumps, platform shoes, moccasins, and the like. Examples of shoes may also include, but is not limited to, athletic shoes such as running shoes, gym shoes, boating shoes, track shoes, football shoes, golf shoes, bowling shoes, hiking shoes, climbing shoes, dance shoes, orthopedic shoes, skating shoes, and the like.

In another preferred embodiment, a RFID device is embedded in a watch at the time of manufacture. The particular placement of the RFID device is not critical to the proper functioning of the present invention. In one preferred embodiment, the watch is a wristwatch. In one embodiment, the RFID device is placed behind the bezel, such as the label identifying the manufacture or a particular product model. In another embodiment, the RFID device is placed within the watch case. In another preferred embodiment, the RFID device is contained within the strap or bracelet. In a less preferred embodiment, the RFID device is embedded post manufacture. Examples of watches includes, but is not limited to, wristwatches, pocket watches, chronographs, chronometers, electromechanical watches, quartz analog watches, digital watches, atomic watches, and the like.

In another preferred embodiment, a RFID device is embedded in an article of jewelry at the time of manufacture. The particular placement of the RFID device is not critical to the proper functioning of the present invention. In one embodiment, the RFID device is placed on the backside of a bracelet, ring, earring, brooch, necklace, pendant, cufflink, or similar article of jewelry. In another embodiment, the RFID device is embedded within the links of the chain, bracelet, necklace, earring, cufflink or similar article of jewelry. In another embodiment, the RFID device is embedded within the clasp of a chain, bracelet, necklace, earring, cufflink, pendant or similar article of jewelry. In another embodiment, the RFID device is located within the setting (for example, under a stone) bracelet, ring, earring, brooch, necklace, pendant, cufflink or similar article of jewelry. In a less preferred embodiment, the RFID device is embedded post manufacture. Examples of jewelry include, but is not limited to, bracelets, necklaces, rings, earrings, pendants, charms, brooch, cufflink, hair ornaments, and the like.

In another preferred embodiment, a RFID device is embedded in a jewelry box at the time of manufacture. The particular placement of the RFID device is not critical to the proper functioning of the present invention. In one embodiment, the RFID device is contained within the piping of the finished product. In another embodiment, the RFID device is placed behind an integral label, such as the label identifying the manufacture or a particular product model. In another embodiment, the RFID device is embedded within the handle or strap. In another embodiment, the RFID device is embedded between two layers of material within the article. In a less preferred embodiment, the RFID device is embedded post manufacture.

In another preferred embodiment, a RFID device is embedded in a wallet at the time of manufacture. The particular placement of the RFID device is not critical to the proper functioning of the present invention. In one embodiment, the RFID device is contained within the piping of the finished product. In another embodiment, the RFID device is placed behind an integral label, such as the label identifying the manufacture or a particular product model. In another embodiment, the RFID device is embedded within the handle or strap. In another embodiment, the RFID device is embedded between two layers of material within the article. In a less preferred embodiment, the RFID device is embedded post manufacture.

In another preferred embodiment, a RFID device is embedded in a scarf at the time of manufacture. The particular placement of the RFID device is not critical to the proper functioning of the present invention. In one embodiment, the RFID device is contained within the piping of the finished product. In another embodiment, the RFID device is placed behind an integral label, such as the label identifying the manufacture or a particular product model. In another embodiment, the RFID device is embedded between two layers of material within the article. In a less preferred embodiment, the RFID device is embedded post manufacture.

In another preferred embodiment, a RFID device is embedded in a golf club bag at the time of manufacture. The particular placement of the RFID device is not critical to the proper functioning of the present invention. In one embodiment, the RFID device is contained within the piping of the finished product. In another embodiment, the RFID device is placed behind an integral label, such as the label identifying the manufacture or a particular product model. In another embodiment, the RFID device is embedded within the handle or strap. In another embodiment, the RFID device is embedded between two layers of material within the article. In a less preferred embodiment, the RFID device is embedded post manufacture.

In another preferred embodiment, a RFID device is embedded in a sports bag at the time of manufacture. The particular placement of the RFID device is not critical to the proper functioning of the present invention. In one embodiment, the RFID device is contained within the piping of the finished product. In another embodiment, the RFID device is placed behind an integral label, such as the label identifying the manufacture or a particular product model. In another embodiment, the RFID device is embedded within the handle or strap. In another embodiment, the RFID device is embedded between two layers of material within the article. In a less preferred embodiment, the RFID device is embedded post manufacture.

In another preferred embodiment, a RFID device is embedded in a painting at the time of preparation. The particular placement of the RFID device is not critical to the proper functioning of the present invention. In one embodiment, the RFID device is contained between the painted canvas and the stretcher. In another embodiment, the RFID device is adhered to the canvas or other medium prior to the artist applying the artistic media, thereby rendering the RFID integral to the piece of art. In another embodiment, the RFID device is embedded between two layers of material within the article. In another embodiment, the RFID device is attached to an exterior surface of the painting. In embodiments relating to pieces of art, it may be necessary to place the RFID post completion of the article. In addition to paintings, this embodiment may also include other object d'art including, inter alia, sculptures.

In certain embodiments, minor changes in the functions and programming can be made at the point of purchase to satisfy the intents and desires of the customer. In certain other embodiments, the RFID is programmed at a manufacturing facility. Such an RFID can be created and/or programmed at the same manufacturing facility where the luxury item is manufactured or it can be manufactured at a remote site.

The foregoing examples are merely intended for the purpose of illustrating the application of the present invention and in no way are intended to limit the scope of the invention or applicability thereof.

In accordance with the present invention, their methods for the identification, authentication, and anti-counterfeiting of the articles described and/or contemplated herein. The following examples, include the application of the methods of the present invention to a handbag, however, it is readily understood and intended that these methods can be applied to any of the other articles described and/or contemplated herein.

In one preferred method of the invention a RFID chip is embedded in a handbag at the time of manufacture. Prior to shipment of the product to a customer, distributor, a retail establishment, the RFID chip is programmed with one or more pieces of information that enable the manufacture to confirm that the product in question is authentic. In a further preferred embodiment, the RFID chip is modified at the time of purchase of the article to include information which identifies the purchaser of the product. In this manner, the authentic product can be tied to the bona fide and/or registered purchaser.

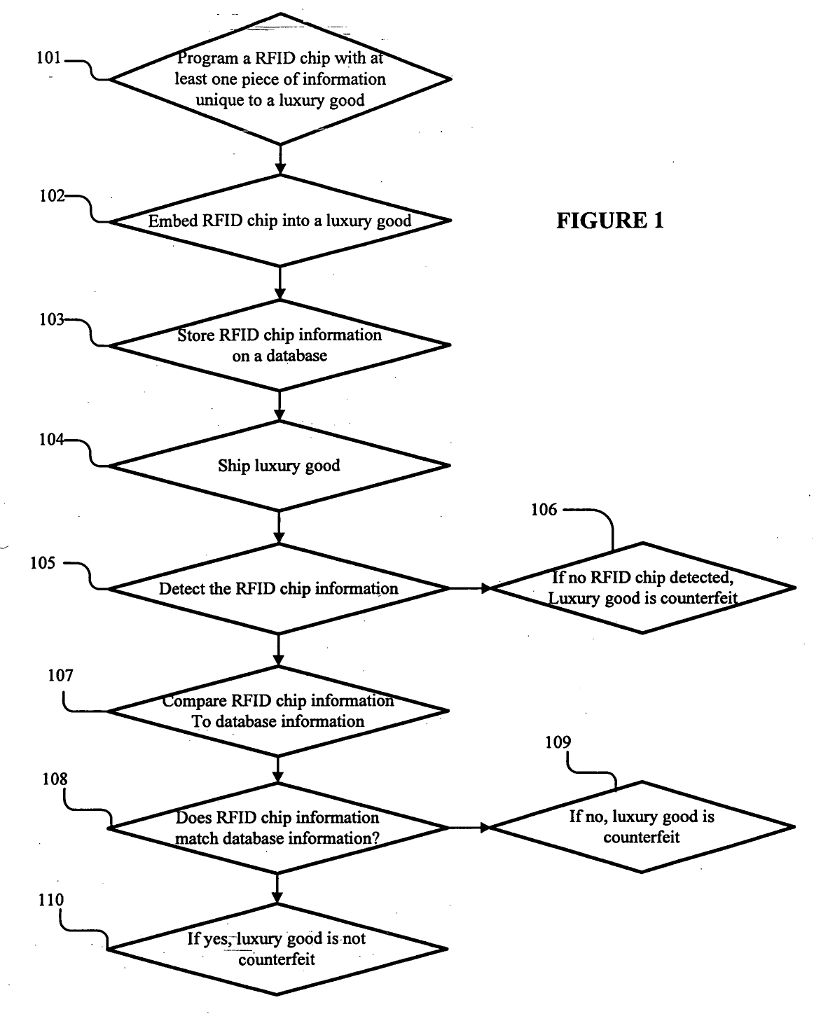

FIG. 1 illustrates one embodiment of the invention. At step 101, prior to shipment of the product to a customer, distributor, a retail establishment, the RFID chip is programmed with one or more pieces of information that enable the manufacture to confirm that the product in question is authentic. The RFID chip is then embedded into the luxury good at step 102. This can occur, for example, at the time of manufacture. The one or more pieces of information programmed on the RFID chip are also stored onto a database at step 103. At step 104, the luxury good is then shipped. The information programmed on the RFID chip is detected at step 105. At step 106, if no RFID chip is detected, the luxury good is deemed counterfeit. If, however, a RFID chip is detected, the information programmed on the RFID chip is compared to the information stored in the database at step 107. If the RFID chip information and the database information match, then at step 110 it is deemed the luxury good is not counterfeit. If the information does not match, than at step 109 the luxury good is deemed to be counterfeit.

It is further contemplated that the detection of the RFID can occur at any point along the supply chain. For instance, in accordance with a preferred embodiment of the methods of the present invention, the RFID is used as a means of product identification and/or authentication by customs officials and/or other law enforcement agents to determine whether articles being imported into a particular jurisdiction are authentic or counterfeit. In a preferred embodiment such customs officials and/or law enforcement agents use an interrogator to verify the authenticity of an individual article, a collection of articles or even an entire shipment container. If the individual article (or collection of articles) do not contain a detectable authenticating RFID signal, the product can be impounded.

In accordance with a preferred embodiment of the methods of the present invention, the RFID is used as a means of product identification and/or authentication by law enforcement agents to determine whether articles being sold (for example, inter alia, in stores, by street vendors, by internet sellers) are authentic or counterfeit. In a preferred embodiment such law enforcement agents use a hand held interrogator to verify the authenticity of an individual article or a collection of articles. If the individual article (or collection of articles) do not contain a detectable authenticating RFID signal the product can be impounded.

In a preferred embodiment, the manufacturer of the articles of the present invention would provide the necessary interrogating devices to the applicable enforcement authority to promote the use and acceptance of such methods, techniques and devices. In a further preferred embodiment, the applicable enforcement authority (whether governmental in nature, such as customs or police, or independent such as “bounty hunters”) are provided a reward for their efforts in deterring the counterfeiting activities in question.

In accordance with another preferred embodiment of the methods of the present invention, the RFID is employed as a means of product identification or authentication by an entity providing warranty, service, repair, replacement, exchange and/or return functions. Said entity employs an interrogator to verify the authenticity of a particular article for which warranty, service, repair, replacement, exchange and/or return functions are requested. If instead the article does not contain a detectable identifying RFID signal the requested function can be denied.

In accordance with another preferred embodiment of the methods of the present invention, the RFID is employed as a means of customer/purchaser identification when said customer enters a retail or similar location.

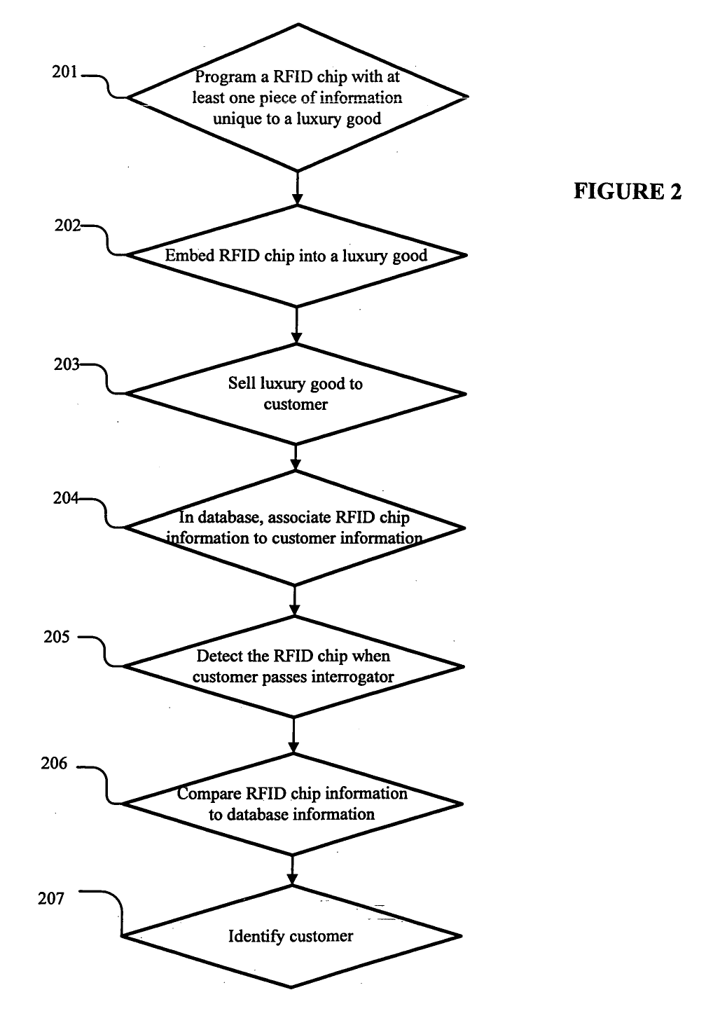

FIG. 2 illustrates another embodiment of the invention. Here, the RFID is employed as a means to identify the luxury good and the customer. In step 201, a RFID chip is programmed with at least one piece of information unique to the luxury good. In step 202, the RFID chip is embedded in the luxury good. This luxury good is then sold to a customer at a retail store in step 203. In step 203, at the time of sale, or at any time convenient to the client, the information programmed into the RFID is associated with the customer identification information in a database. This database can be local or remote to the store, as long as the store can access the database at will. In accordance with this embodiment, an interrogator is employed at or near the entrance of the retail location. At step 205, when the client later re-visits the retail store, if the customer is carrying the luxury good previously purchased with him/her, the RFID chip within the luxury good is detected by an interrogator when the client enters the store. The RFID chip information is then compared to the customer identification information in the database, at step 206. If the RFID chip information matches the customer identification information, the store personnel will be notified of the identity of the customer at step 207. This greatly assists the employees of the retail location as they can identify the customer in advance of the customer having to identify themselves. In accordance with this embodiment, the retailer is able to provide a high level of personal service thereby adding to the customer's service experience.

In accordance with another preferred embodiment of the methods of the present invention, the RFID is employed as a means of maintaining the intrinsic value of the articles of the present invention. Increasingly, purchasers of luxury items are deterred in their consumer activities by the presence of counterfeit items being sold on the open market. The manufacturer and/or retailer are able to promote the RFID tagged articles of the present invention as bona fide, with the ability to confirm the bona fide nature of such articles. Thus, the intrinsic value of an item is maintained and/or enhanced through the use of the present invention. Indeed, the RFID can be programmed to activate other electronic devices either within or outside of the luxury item.

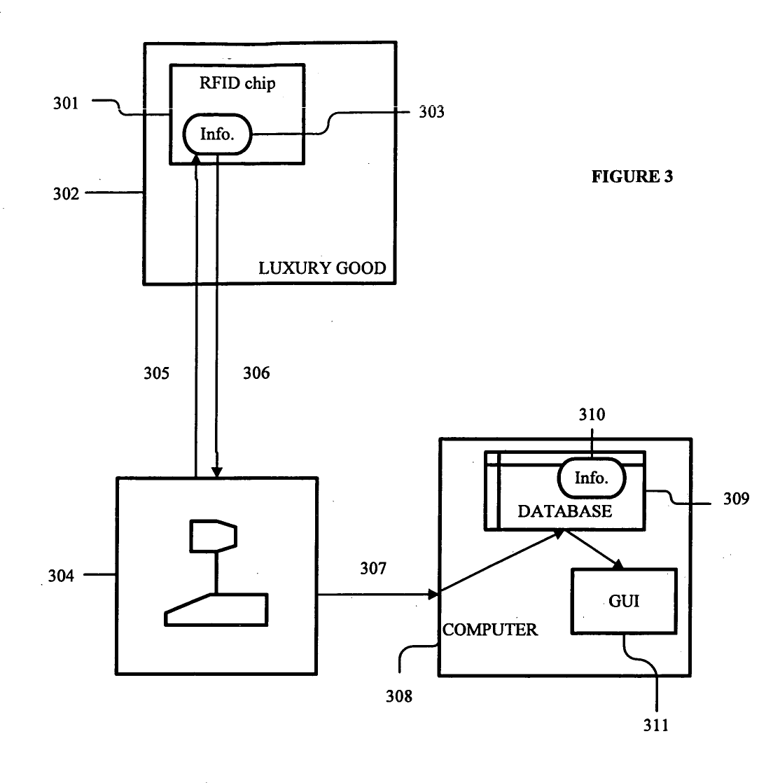

FIG. 3 illustrates a system for detecting the RFID chip in a luxury good. The system comprises a RFID chip (301) located within a luxury good (302). The RFID chip is programmed with information (303) unique to the luxury good (302). When the RFID chip comes with in the range of an interrogator (304), a coded RF signal is sent from the stationary or mobile interrogator (305). The RFID chip reflects the incident RF back to the interrogator (306) thereby informing the interrogator of the information unique to the luxury good. The interrogator (304) transfers this information to a computer (308). The transfer of information can be by any communication means (307). Software that accesses or administrates the database functionality then compares information (310) stored within the database (309) to the RFID chip information (303). If the RFID chip information (303) is matched to the database information (310), then a graphical user interface (311) notifies the user that the RFID chip is authentic and thus the luxury good is not counterfeit. If the RFID chip information (303) does not match the database information (310) then the graphical user interface (311) notifies the user that the RFID chip is not authentic and thus the luxury good is counterfeit. In another embodiment, the RFID chip information (303) and/or computer database information (310) comprises consumer identification information. As such, the graphical user interface (311) may show the consumer identification information. This is an important feature in accordance with another preferred embodiment of the methods of the present invention, whereby the RFID is employed as a means of theft deterrent. Because each article is uniquely identified and manufacture, and the identification can be uniquely tied to the bona fide purchaser, the theft of such articles can be deterred by the knowledge that the items in question are identified with what in essence amounts to an electronic “fingerprint.” This electronic fingerprint enables the article to be identified should a thief, seller of stolen goods or recipient of stolen goods be caught with that item in his or her possession.

In accordance with another preferred embodiment of the methods of the present invention, the RFID is employed as a means of locating the bona fide and/or registered owner of a lost or stolen article.

In accordance with another preferred embodiment of the methods of the present invention, registries of the articles of the present invention can be prepared in order to track shipment, transfer, sale, ownership, and/or similar information for a variety of purposes including, inter alia, manufacture, distribution, sales, ownership and similar purposes. Such registries can be private (i.e., not accessible by unauthorized persons) or publicly accessible. Such registries are intended to provide various benefits including, inter alia, efficiencies in the manufacture and sale of the articles of the present invention and proof of ownership, which in the case of certain luxury items, can provide an added benefit of notoriety with certain consumers.

In one preferred embodiment, the information contained within the RFID tag or label is matched to at least one database of information contained on at least one computer. This information may include, but is not limited to, ownership history, customer identification information such as customer name, customer contact information, customer shopping history, customer shopping preferences, customer item return history, product warranty information, product service history, product repair history, item authenticity information, shipment tracking history, item manufacturing history, business transaction data and the like. Further, in another embodiment, the information may be queried remotely by a customer, the item manufacturer, the item distributor, law enforcement authorities, and the like. Further, in one embodiment, the at least one computer containing such database of information may be located at the store, located remotely, or distributed across a network. The computer containing such database of information may be owned and maintained by the store, item manufacturer, third party vendor, distributor, and the like.

It should be appreciated that the network described herein may include any system for exchanging data or transacting business, such as Internet, intranet, extranet, WAN, LAN, satellite communication, cellular phone communications, and the like. Further, the communications between entities concerning the transaction or access request can occur by any mechanism, including but not limited to, Internet, intranet, extranet, WAN, LAN, point of interaction device (point of sale device, personal digital assistant, cellular phone, kiosk, etc.), online communication, off line communication, and wireless connection. The present invention might further employ any number of conventional techniques for data transmission, signaling, data processing, network control, and the like. For example, radio frequency and other wireless techniques can be used in place of any network technique described herein.

It is to be understood that other embodiments may be utilized and structural and functional changes may be made without departing from the scope of the present invention. The descriptions of embodiments of the invention presented herein are provided for purposes of illustration and description and are in no way intended to be exhaustive or to limit the invention to the precise forms disclosed. Accordingly, many modifications and variations are possible in light of the above teachings and the knowledge of persons of ordinary skill in the relevant arts without departing from the present invention. It is therefore intended that the scope of the invention not be limited to the foregoing examples.

1. A method of detecting counterfeit luxury goods comprising,
programming a RFID chip with at least one piece of information;
embedding said RFID tag into a newly manufactured luxury good item, whereby the at least one piece of information is unique to the luxury good item;
storing data corresponding to said at least one piece of information on a database;
detecting the at least one piece of information on the RFID chip;
comparing the information on the RFID chip to data stored on a database;
whereby the luxury good is counterfeit if the at least one piece of information does not correspond to data stored on the database.

2. The method of claim 1, further comprising programming the RFID chip with at least one item of encoded information unique to a customer.

3. The method of claim 1, whereby said luxury good is sold to a customer by a retail store and whereby said database is enabled to add customer identification information to the data stored on said database.

4. The method of claim 3, whereby said data stored on said database further comprises customer identification information, and whereby said customer identification information is selected from the group consisting of: customer name, customer contact information, customer shopping history, customer shopping preferences, customer item return history, product warranty information, product service history, product repair history, item authenticity information, business transaction data, and a mix thereof.

5. The method of claim 1, whereby the detecting of the at least one piece of information on said RFID occurs at a retail store.

6. The method of claim 1, whereby the detecting of the at least one piece of information on said RFID chip occurs by a law enforcement agent.

7. The method of claim 1, whereby the RFID chip is a fixed to the luxury good item.

8. A system for identifying a customer comprising,
a RFID embedded into a luxury good previously purchased by said customer,
whereby said RFID is programmed to contain at least one piece of information unique to said luxury good,
at least one RFID detector located within a retail store,
a communication means between said at least one RFID detector and at least one database associated with at least one computer,
whereby said database comprises customer identification information,
whereby said database is capable of associating the at least one piece of information unique to said luxury good to said customer identification information.

9. A system for identifying a customer comprising,
a RFID embedded into a luxury good previously purchased by said customer, whereby said RFID is programmed with at least one piece of customer identification information,
at least one RFID detector located within a retail store,
a communication means between said at least one RFID detector and at least one database associated with at least one computer,
whereby said database comprises at least one piece of customer identification information,
whereby said database is capable of associating the at least one piece of information unique to said luxury good to said customer identification information.
